(19) United States
(12) Patent Application Publication
(10) Pub. No.: US 2008/0224992 A1
(43) Pub. Date: Sep. 18, 2008

(54) ELECTROPHORETIC DISPLAY AND METHOD OF DRIVING THE SAME

(76) Inventors: Jong-Hee KIM, Seoul (KR); Cheol-Woo Park, Suwon-si (KR)

Correspondence Address: MACPHERSON KWOK CHEN & HEID LLP, 2033 GATEWAY PLACE, SUITE 400, SAN JOSE, CA, 95110, US

(21) Appl. No.: 12/046,291

(22) Filed: Mar. 11, 2008

(30) Foreign Application Priority Data
Mar. 14, 2007 (KR) 2007-025204

(51) Int. Cl. G09G 3/34

(52) U.S. Cl. 345/107

(57) ABSTRACT

In an electrophoretic display, a display panel includes a first electrode receiving a data voltage, a second electrode receiving a common voltage while facing the first electrode and a plurality of pixels each of which includes charged particles arranged between the first electrode and the second electrode. The display panel receives the data voltage in response to a gate signal at a high state during a data output period to display an image, maintains a current image in response to the gate signal at a low state during a maintaining period, and receives a refresh voltage in response to the gate signal at the high state to reset the image. Thus, the electrophoretic display may prevent distortion of the image during the maintaining period.

### CROSS-REFERENCE TO RELATED APPLICATION

This application relies for priority upon Korean Patent Application No. 10-2007-25204 filed on Mar. 14, 2007, the contents of which are herein incorporated by reference in its entirety.

### BACKGROUND OF THE INVENTION

1. Field of the Invention

The present invention relates to an electrophoretic display and a method driving the electrophoretic display. More particularly, the present invention relates to an electrophoretic display capable of improving display quality and a method of driving the electrophoretic display.

2. Description of the Related Art

In general, the types of display apparatuses for receiving image signals to display images include a Cathode Ray Tube (CRT) type display apparatus, a Liquid Crystal Display (LCD) type, and an Electrophoretic Display (EPD) type.

A CRT display apparatus has a vacuum tube therein and displays images by using an electron beam output from an electron gun. Since the CRT display apparatus needs to ensure a distance sufficient to enable rotation of the electron beam, the CRT display apparatus can be extremely thick and heavy. An LCD displays images by using the optical characteristics of liquid crystals and is thinner and lighter than the CRT display apparatus. However, since conventional LCDs use a backlight assembly in order to provide light to display images, there is a limit to how slim and light the LCD can be made.

An EPD displays images by using an electrophoretic effect, in which charged pigment particles move by an electric field applied between upper and lower substrates thereof. Since the EPD is a reflective-type display displaying images by using external light, a separate light source is not used. Accordingly, the EPD is thinner and lighter weight than a comparable LCD display.

When a new image is not provided, the EPD uses charged pigment particles that maintain a current image. Thus, a maintaining period during which a data voltage is maintained exists even after a data output period during which the data voltage output. However, when a gate signal is generated during the maintaining period, the electric field applied between upper and lower substrates by the data voltage varies, so that the images displayed on the EPD are distorted.

### SUMMARY OF THE INVENTION

An electrophoretic display capable of removing afterimages and flickering is provided.

A method of driving the electrophoretic display is also provided.

In one aspect of the present invention, an electrophoretic display includes a gate driver, a data driver and a display panel. The gate driver sequentially outputs gate signals at a high state during a first period, outputs the gate signal at a low state during a second period, and outputs the gate signals at the high state during a third period. The data driver outputs a data voltage corresponding to an image data during the first period and outputs a refresh voltage during the third period.

The display panel includes a first electrode receiving the data voltage, a second electrode receiving a common voltage while facing the first electrode and a plurality of pixels each of which includes charged particles disposed between the first electrode and the second electrode. The display panel receives the data voltage in response to the gate signals at the high state during the first period to display an image, maintains the image in response to the gate signals at the low state during the second period, and receives the refresh voltage in response to the gate signals at the high state during the third period to reset the image.

In another aspect of the present invention, a method of driving an electrophoretic display is provided as follows. A gate signal at a first state is applied during a first period, and a data voltage corresponding to an image data provided from an exterior is generated. When the data voltage is input in response to the gate signal at the first state, an electric field is formed by a voltage difference between the data voltage and a common voltage, and a first pigment particle and a second pigment particle electrified with different polarities move toward different directions to display an image having a desired gray-scale. The gate signal is maintained at a second state during a second period, and the image is maintained its current state in response to the gate signal at the second state. The gate signal at the first state is sequentially generated during a third period, and a refresh voltage is generated during the third period. When the refresh voltage is input in response to the gate signal at the first state, the image is reset.

According to the above, since the gate signal at the high state is not output during the maintaining period, the data voltage is prevented from being changed during the maintaining period, thereby preventing a distortion of the image.

### BRIEF DESCRIPTION OF THE DRAWINGS

The above and other advantages of the present invention will become readily apparent by reference to the following detailed description when considered in conjunction with the accompanying drawings wherein:

FIG. 1 is a block diagram showing an exemplary embodiment of an electrophoretic display according to the present invention;

FIGS. 2A to 2C are diagrams showing directionalities of charged particles according to an electric field;

FIG. 3 is a timing diagram showing signals of FIG. 1;

FIG. 4 is a block diagram showing another exemplary embodiment of an electrophoretic display according to the present invention;

FIG. 5 is a circuit diagram showing a voltage controller of FIG. 4; and

FIG. 6 is a timing diagram showing signals of FIG. 4.

### DESCRIPTION OF THE EMBODIMENTS

Hereinafter, the present invention will be explained in detail with reference to the accompanying drawings. In the drawings, the thickness of layers, films, and regions are exaggerated for clarity. Like numerals refer to like elements throughout. It will be understood that when an element such as a layer, film, region, or substrate is referred to as being “on” another element, it can be directly on the other element or intervening elements may also be present.

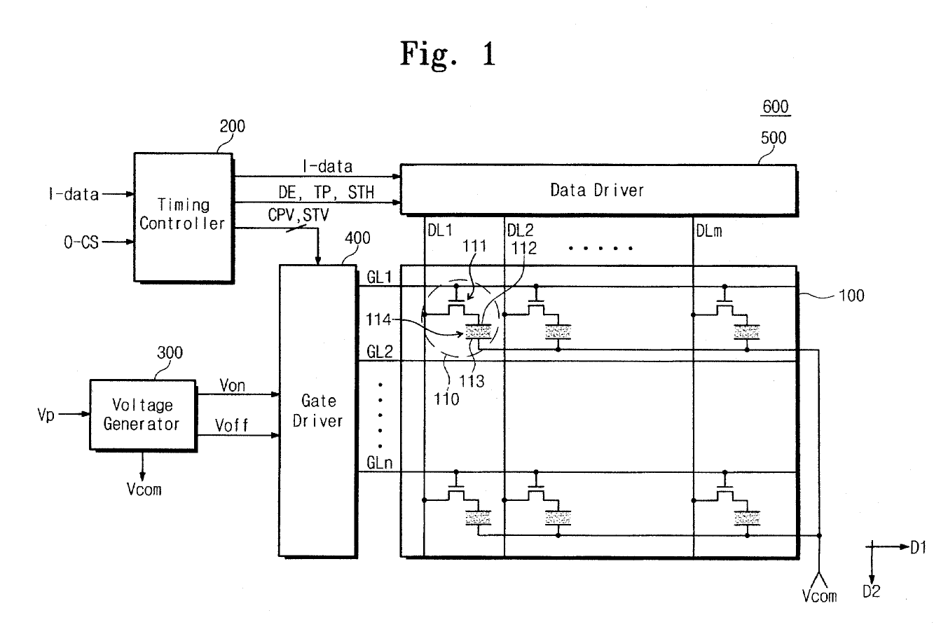

FIG. 1 is a block diagram showing an exemplary embodiment of an electrophoretic display according to the present invention.

Referring to FIG. 1, an electrophoretic display 600 includes a display panel 100, a timing controller 200, a voltage generator 300, a data driver 500 and a gate driver 400.

The display panel 100 includes a plurality of data lines DL1˜DLm, a plurality of gate lines GL1˜GLn and a plurality of pixels 110 arranged in a plurality of pixel areas that are defined by the data lines DL1˜DLm and the gate lines GL1˜GLn.

The gate lines GL1˜GLn extend in a first direction D1 and are arranged in a second direction D2 that is substantially perpendicular to the first direction D1, as shown in FIG. 1. The data lines DL1˜DLm extend in the first direction D1 while being insulated from and overlapping with the gate lines GL1˜GLn.

Each of the pixels 110 includes a thin film transistor 111, a pixel electrode 112, a common electrode 113 facing the pixel electrode 112, and a plurality of microcapsules 114 arranged between the pixel electrode 112 and the common electrode 113.

The thin film transistor 111 includes a gate electrode electrically connected to one of the corresponding gate lines among the gate lines GL1˜GLn, a source electrode connected to one of the corresponding data lines among the data lines DL1˜DLm, and a drain electrode connected to one of the corresponding pixel electrodes among the pixel electrodes 112.

In FIG. 1, the thin film transistor 111 is turned on in response to a gate-on voltage Von applied from the corresponding gate line, and provides a data voltage applied from the corresponding data line to the pixel electrode 112. The common electrode 113 receives a common voltage Vcom. Thus, an electric field is formed between the common electrode 113 and the pixel electrode 112 by an electric potential difference between the data voltage and the common voltage Vcom.

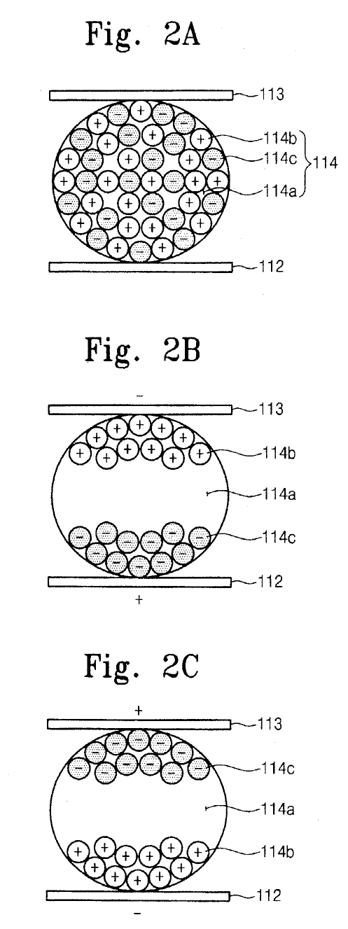

The microcapsules 114 are arranged between the common electrode 113 and the pixel electrode 112, and include black particles and white particles electrified with different polarities. The black and white particles move according to the magnitude and direction of the electric field formed between the pixel electrode 112 and the common electrode 113 to display a gray-scale. Detailed descriptions regarding the movement of the charged particles in the microcapsules 114 will be provided below with reference to FIGS. 2A to 2C.

The timing controller 200 receives an image data I-data and various control signals O-CS from an external device. The timing controller 200 transmits the image data I-data and the various control signals O-CS to the gate driver 400 and the data driver 500. In particular, a first start signal STV and a clock signal CPV among the various control signals O-CS are applied to the gate driver 400. The image data I-data, a data enable signal DE, an output start signal TP and a second start signal STH are applied to the data driver 500.

The voltage generator 300 receives a power voltage Vp and generates a gate-on voltage Von and a gate-off voltage Voff. The gate-on voltage Von and the gate-off voltage Voff are provided by the voltage generator 300 to gate lines GL1˜GLn. Also, the voltage generator 300 outputs the common voltage Vcom to apply the common voltage Vcom to the common electrode 113. The common voltage Vcom may have the same voltage level as that of a ground voltage and the gate-off voltage may have a voltage level that is lower than that of the common voltage.

The gate driver 400 starts its operation in response to the first start signal STV and provides gate signals to the gate lines GL1˜GLn in response to the clock signal CPV. The gate signals include the gate-on voltage Von and the gate-off voltage Voff. During 1H period, each gate line receives the gate-on voltage Von at least two times according to a clock signal CPV. Each gate line receives the gate-on voltage Von for a data output period T1 and a refresh period T3, and also receives the gate-off voltage Voff for a maintaining period T2.

While the gate signal having the gate-on voltage Von is applied to the corresponding gate line and the thin film transistors connected to the corresponding gate line receiving the gate-on voltage Von are turned on, the gate signals having the gate-off voltage Voff are applied to the other gate lines and the thin film transistors connected to the other corresponding gate lines receiving the gate-off voltage Voff are turned off.

The data driver 500 receives the image data I-data and generates the data voltage in response to the data enable signal DE, the output start signal TP and the second start signal STH. Then the data voltage is provided to the data lines DL1˜DLm for a predetermined time period. Each data voltage applied to the data lines DL1˜DLm is provided to the each pixel electrode 112 through the thin film transistor that is turned on by the gate-on voltage Von.

An electric field is formed between the pixel electrode 112 to which the data voltage is applied and the common electrode 113 to which the common voltage Vcom is applied. Accordingly, the black and white particles included in the microcapsules 114 move according to a direction in which the electric field is formed. Gray-scale values of images displayed in the pixels vary according to the movement distance of the black and white particles. The movement distance of the black and white particles are determined by how much time the data voltage is applied to the pixel electrode 112. Thus, the gray-scale values of the images displayed in pixels may be determined by increasing the time during which the data voltage is applied in order to display a high gray-scale image or by decreasing the time during which the data voltage is applied in order to display a low gray-scale image.

FIGS. 2A to 2C are diagrams showing directionalities of charged particles according to an electric field.

Referring to FIG. 2A, the microcapsules 114 are arranged between the pixel electrode 112 and the common electrode 113. In the present exemplary embodiment, the pixel electrode 112 and the common electrode 113 include a transparent conductive material such as Indium Tin Oxide (ITO).

The microcapsules 114 includes a dispersive medium 114a filled with a transparent insulating liquid, first pigment particles 114b and second pigment particles 114c. The first pigment particles 114b and second pigment particles 114c are dispersed in the dispersive medium 114a and are electrified with different electric charges.

The dispersive medium 114a includes surfactants and has the same specific gravity as the first and second pigment particles 114b and 114c. Accordingly, the first and second pigment particles 114b and 114c can prevent precipitation of the first and second pigment particles 114b and 114c caused by gravity. Also, in the absence of an applied voltage, the dispersive medium 114a may maintain a fairly regular distribution of the first and second pigment particles 114b and 114c within the charged particle cell 114.

In the present exemplary embodiment, the first pigment particles 114b are electrified with a positive electric charge (+) and include a material such as Titanium dioxide (TiO₂) so as to have a white color. The second pigment particles 114c are electrified with a negative electric charge (−) and include a carbon powder such as a carbon black so as to have a black color.

When the electric field is not applied between the pixel electrode 112 and the common electrode 113, the first pigment particles 114b and the second pigment particles 114c do not have a directionality, so that the first and second pigment particles 114b and 114c are disorderly arranged between the pixel electrode 112 and the common electrode 113.

As shown in FIG. 2B, when a data voltage having a positive polarity (+) with respect to the common voltage applied to the common electrode 113 is applied to the pixel electrode 112, an electric field is formed between the pixel electrode 112 and the common electrode 113.

The first pigment particles 114b electrified with the positive electric charge move toward the common electrode 113, and the second pigment particles 114c electrified with the negative electric charge move toward the pixel electrode 112. As described above, when the electric field having a positive polarity (+) is formed between the pixel electrode 112 and the common electrode 113, the first pigment particles 114b are recognized in a pixel as an image.

The speed of movement of the first pigment particles 114b and the second pigment particles 114c is determined by an intensity of the electric field, that is, a voltage difference. Also, a movement distance of the first pigment particles 114b and the second pigment particles 114c is determined by the length of time that the data voltage having a constant voltage level is applied. Therefore, upper and lower positions of the first and second pigment particles 114b and 114c may be controlled by adjusting the time during which the data voltage is applied. Consequently, as shown in FIG. 2B, as the time during which the data voltage is applied increases, the visibility of the first pigment particles 114b increases, thereby displaying a white gray-scale.

When the voltage difference between the pixel electrode 112 and the common electrode 113 is removed, the first and second pigment particles 114b and 114c stop their movement. In other words, the first and second pigment particles 114b and 114c may be maintained in their current arrangement before a new data voltage is applied.

As described above, when the pixel recognizes the first pigment particles 114b, an incident light through the common electrode 113 is reflected by the first pigment particles 114b and the reflected light exits through the common electrode 113, so that a user may recognize a white gray-scale image.

As shown in FIG. 2C, when a data voltage having a negative polarity (−) with respect to the common voltage applied to the common electrode 113 is applied to the pixel electrode 112, the electric field is formed between the pixel electrode 112 and the common electrode 113.

The first pigment particles 114b electrified with the positive electric charge move toward the pixel electrode 112, and the second pigment particles 114c electrified with the negative electric charge move toward the common electrode 113. As described above, when the electric field having the negative polarity (−) is formed between the pixel electrode 112 and the common electrode, the second pigment particles 114c are recognized in a pixel as an image.

As described above, when the pixel recognizes the second pigment particles 114c, an incident light through the common electrode 113 is absorbed by the second pigment particles 114c and the light does not exit through the common electrode 113, so that the user may recognize a black gray-scale image.

In the present exemplary embodiment, the microcapsules 114 including the white pigment particles and the black pigment particles have been described. However, according to another exemplary embodiment, the microcapsules 114 may include the white particles or the black particles and at least one among red R, green G, and blue B particles.

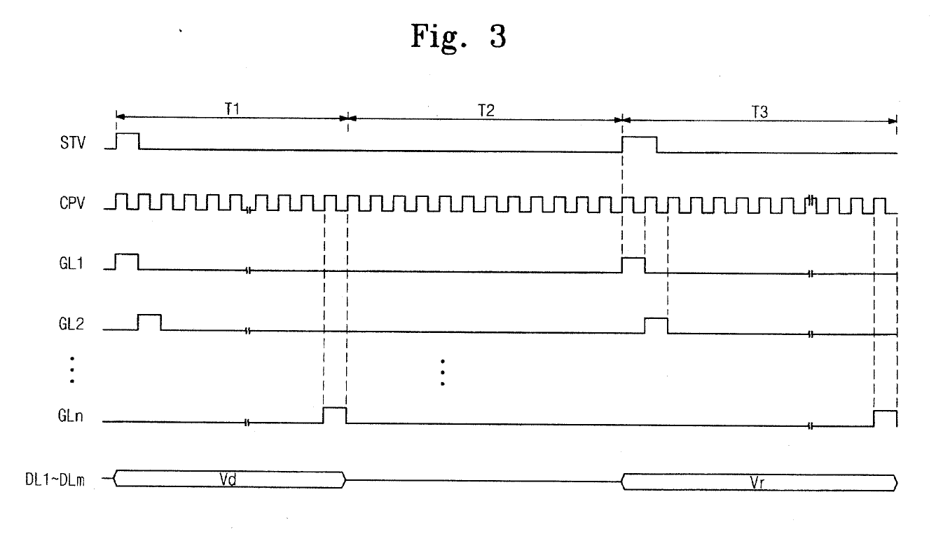

FIG. 3 is a timing diagram showing the signals of FIG. 1.

Referring to FIG. 3, the electrophoretic display 600 (shown in FIG. 1) is operated over a data output period T1, a maintaining period T2 and a refresh period T3.

In particular, the data driver 500 (shown in FIG. 1) outputs the data voltage Vd to the data lines DL1˜DLm during the data output period T1. The gate-on voltage Von is sequentially applied to the gate lines GL1˜GLn during the data output period T1 so that the data voltage Vd on the data lines DL1˜DLm is applied to the pixel electrodes 112 (shown in FIG. 1). The gate driver 400 (shown in FIG. 1) starts its operation in response to the first start signal STV, and then sequentially applies the gate-on voltage Von to the gate lines GL1˜GLn in response to the clock signal CPV. The thin film transistors 111 (shown in FIG. 1) are turned on by the gate-on voltage Von, so that the data voltage Vd may be applied to the pixel electrodes 112.

The electric field is formed between the common electrode 113 (shown in FIG. 1) and the pixel electrode 112 by the electric potential difference between the common voltage Vcom (shown in FIG. 1) applied to the common electrode 113 and the data voltage Vd, and the movement directions of the first pigment particles 114b and the second pigment particles 114c are determined by the direction in which the electric field is formed.

The pigment particles in the microcapsules 114 maintain their current state until a new electric field is formed by a different data voltage. Thus, after the data output period T1, the electrophoretic display 600 has a maintaining period T2 during which the data driver 500 does not provide a new data voltage to maintain the current image.

Since the data driver 500 does not provide any data voltage during the maintaining period T2, the gate driver 400 does not need to sequentially apply the gate-on voltage Von to the gate lines GL1˜GLn in order to turn on the thin film transistors 111. Thus, the first start signal STV that starts the operation of the gate driver 400 is maintained at a low state during the maintaining period T2. As a result, the gate driver 400 may continuously apply the gate-off voltage Voff to the gate lines GL1˜GLn during the maintaining period T2. When the thin film transistors 111 are maintained in an off state in response to the gate-off voltage Voff during the maintaining period T2, the data voltage Vd applied to the pixels is not varied, thereby maintaining during the maintaining period T2 the image generated during the data output period T1.

In order to reset a current data voltage before a new data voltage inputs, the data driver 500 outputs a refresh voltage Vr to the data lines DL1 DLn during the refresh period T3. The refresh voltage is a voltage which resets the position of charges to prevent currently displayed images from being preserved in each pixel. Thus, the pixels that maintain the current data voltage are reset to the refresh voltage Vr. The refresh voltage Vr may be a white voltage or a black voltage allowing the pixels to be the white gray-scale or the black gray-scale, respectively.

The thin film transistors 111 are turned on in order to apply the refresh voltage Vr to the pixels. Thus, the first start signal STV is generated at the high state in order to start the operation of the gate driver 400 at a start point of the refresh period T3. Therefore, the gate driver 400 sequentially outputs the gate-on voltage Von to the gate lines GL1˜GLn, so that the refresh voltage Vr may be applied to the pixels.

As a result, the first start signal STV is generated at the high state at the start point of the data output period T1 and the refresh period T3, and is maintained at the low state during the maintaining period T2, thereby preventing the output of the gate-on voltage Von from the gate driver 400 during the maintaining period T2. Thus, the electrophoretic display 600 may prevent the images displayed thereon from being distorted during the maintaining period T2.

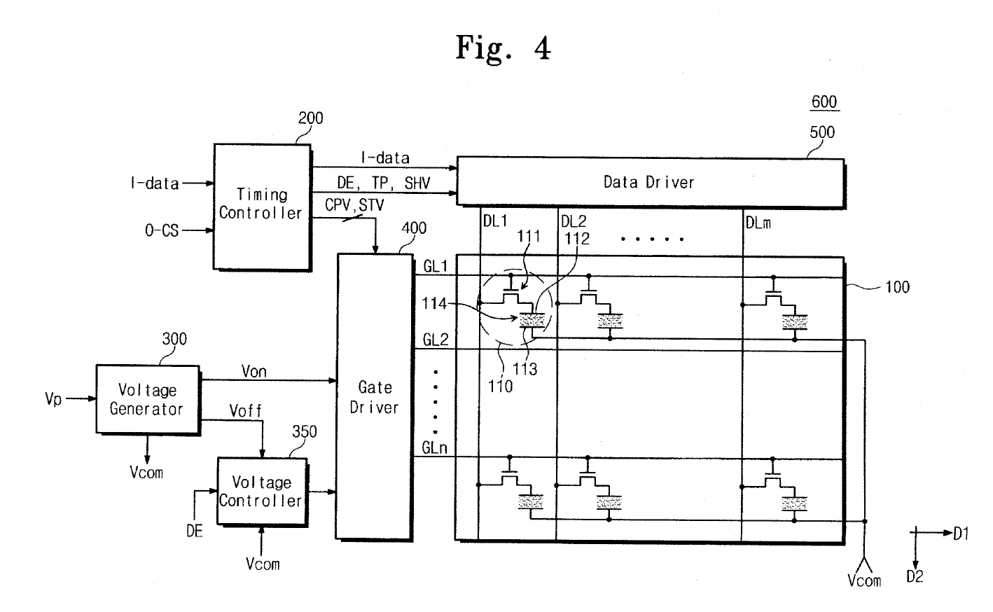

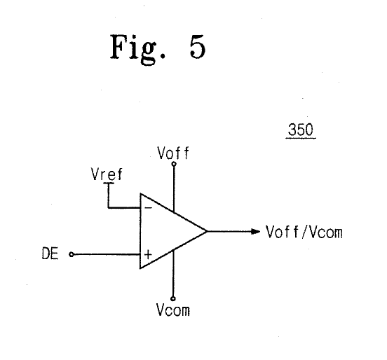

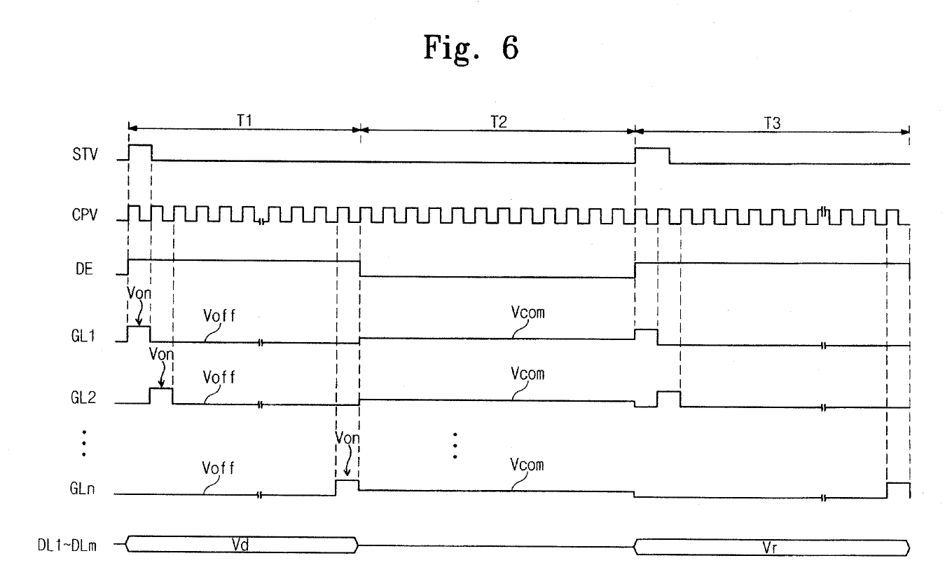

FIG. 4 is a block diagram showing another exemplary embodiment of an electrophoretic display according to the prevent invention, FIG. 5 is a circuit diagram showing a voltage controller of FIG. 4, and FIG. 6 is a timing diagram showing the signals of FIG. 4. In FIG. 4, the same reference numerals denote the same elements in FIG. 1, and thus the detailed descriptions of the same elements will be omitted.

Referring to FIG. 4, an electrophoretic display 600 further includes a voltage controller 350 arranged between a voltage generator 300 and a gate driver 400.

The voltage generator 300 generates a common voltage Vcom, a gate-on voltage Von and a gate-off voltage Voff in response to a power voltage Vp. Then the gate-on voltage Von is applied to the gate driver 400, and the common voltage Vcom and the gate-off voltage Voff are applied to the voltage controller 350.

As shown in FIGS. 5 and 6, the voltage controller 350 receives a data enable signal DE, a gate-off voltage Voff and a common voltage Vcom. In response to the data enable signal DE, the voltage controller 350 generates the gate-off voltage Voff or a common voltage Vcom. More specifically, while the data enable signal DE is maintained at a high state during a data output period T1 and a refresh period T3, the voltage controller 350 generates and provides a gate-off voltage Voff to the gate driver 400. However, while the data enable signal DE is maintained at a low state during a maintaining period T2, the voltage controller 350 generates and provides a common voltage Vcom to the gate driver 400. Meanwhile, the data voltage Vd and the refresh voltage Vr are provided from a data driver 500 to the data lines DL1˜DLm during a data output period T1 and a refresh period T3, respectively. During a maintaining period T2, the data driver 500 stops its operation.

The voltage controller 350 compares the data enable signal DE with a predetermined reference voltage Vref. During the data output period T1 and the refresh period T3, the voltage controller 350 selects the gate-off voltage Voff during which the data enable signal DE is high, and then provides the gate-off voltage Voff to the gate driver 400. Thus, the gate driver 400 outputs the gate-on voltage Von to a gate line that is selected and the gate-off voltage Voff to a gate line that is not selected. Specifically, the data voltage Vd is provided during the data output period T1 and the refresh voltage Vr is provided during the refresh period T3.

During the maintaining period T2, the voltage controller 350 selects the common voltage Vcom between the gate-off voltage Voff and the common voltage Vcom and applies the common voltage Vcom to the gate driver 400. Thus, the gate driver 400 outputs the common voltage Vcom to the gate lines GL1˜GLn. In the present exemplary embodiment, the Vcom may have a ground voltage level.

When the common voltage Vcom is applied to the gate lines GL1˜GLn during the maintaining period T2, a voltage difference between the common electrode 113 and the gate lines GL1˜GLn does not exist, so that a parasitic capacitance is not formed between the common electrode 113 and the gate lines GL1˜GLn, which causes afterimages or a white or a black flickering on a display screen of the electrophoretic display 600. Thus, the electrophoretic display 600 may have an improved display quality by removing the parasitic capacitance through the above described methods.

According to the above, since the gate signal at the high state is not generated during the maintaining period T2, the data voltage is also prevented from being changed during the maintaining period T2, thereby preventing a distortion of the image.

Also, the common voltage is provided to the gate driver in lieu of the gate-off voltage to allow the gate signal at the low state to have the same voltage level as that of the common voltage during the maintaining period, so that the parasitic capacitance between the gate lines and the common electrode may be removed. Thus, the afterimage and the flickering may be prevented, and the display quality of the electrophoretic display may be improved.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. An electrophoretic display comprising:
a gate driver sequentially outputting gate signals at a high state during a first period, outputting the gate signals at a low state during a second period and outputting the gate signals at the high state during a third period;
a data driver outputting a data voltage corresponding to an image data during the first period and outputting a refresh voltage during the third period; and
a display panel receiving the data voltage in response to the gate signals at the high state during the first period to display an image, maintaining the image in response to the gate signals at the low state during the second period and receiving the refresh voltage in response to the gate signals at the high state during the third period to reset the image, the display panel comprising a first electrode receiving the data voltage, a second electrode receiving a common voltage while facing the first electrode, and a plurality of pixels each of which includes charged particles disposed between the first electrode and the second electrode.

2. The electrophoretic display of claim 1, wherein the gate driver outputs the gate signal based on a first start signal and a clock signal, and the first start signal is generated at the high state at least once during the first period and the third period and generated at the low state during the second period in order to start an operation of the gate driver.

3. The electrophoretic display of claim 2, further comprising:
a timing controller receiving the image data and various control signals from an external device to generate the first start signal and the clock signal provided to the gate driver, and controlling an output timing of the image data and the data voltage to the data driver; and
a voltage generator generating a gate-on voltage and a gate-off voltage based on a power voltage.

4. The electrophoretic display of claim 3, wherein the gate driver receives the gate-on voltage and the gate-off voltage.

5. The electrophoretic display of claim 4, wherein the gate signal at the high state has the same voltage level as that of the gate-on voltage, and the gate signal at the low state has the same voltage level as that of the gate-off voltage.

6. The electrophoretic display of claim 3, further comprising a voltage controller selecting either the gate-off voltage or the common voltage based on the data enable signal to provide the selected voltage to the gate driver, the voltage controller being arranged between the gate driver and the voltage generator.

7. The electrophoretic display of claim 6, wherein the gate-off voltage has a voltage level that is lower than that of the common voltage.

8. The electrophoretic display of claim 6, wherein the voltage controller selects the common voltage during the second period to provide the common voltage to the gate driver, and the gate driver receives the gate-on voltage from the voltage generator.

9. The electrophoretic display of claim 8, wherein the gate signal at the low state has a same voltage level as that of the common voltage during the second period.

10. The electrophoretic display of claim 6, wherein the common voltage has a same voltage level as that of a ground voltage.

11. The electrophoretic display of claim 6, wherein the data enable signal applied to the voltage controller is generated at the high state during the first period and the third period and generated at the low state during the second period, and the voltage controller compares the data enable signal with a predetermined reference signal to output the common voltage during the second period.

12. The electrophoretic display of claim 1, wherein each of the charged particles comprises:
a dispersive medium including a transparent insulating material; and
first and second pigment particles dispersed in the dispersive medium and electrified with different polarities.

13. The electrophoretic display of claim 12, wherein each of the first and second pigment particles moves toward one electrode of the first and second electrodes, which is having an opposite polarity to that of the first or second pigment particle adjacent thereto when an electric field is formed between the first electrode and the second electrode.

14. The electrophoretic display of claim 12, wherein one of the first and second pigment particles comprises a white color and a remaining one of the first and second pigment particles comprises a black color.

15. A method of driving an electrophoretic display, comprising:
applying gate signals of a first state during a first period;
generating a data voltage corresponding to an image data provided from an external device during the first period;
receiving the data voltage in response to the gate signals of the first state to generate an electric field caused by a voltage difference between the data voltage and a common voltage, and moving a first pigment particle and a second pigment particle electrified with different polarities toward different directions to display an image having a desired gray-scale during the first period;
applying gate signals at a second state during a second period;
applying gate signals at the first state during a third period;
generating a refresh voltage during the third period; and
receiving the refresh voltage in response to the gate signals of the first state to reset the image.

16. The method of claim 15, wherein one of the first and second pigment particles comprises a white color and a remaining one of the first and second pigment particles comprises a black color.

17. The method of claim 15, wherein the gate signal is generated based on a first start signal and a clock signal, and the first start signal is generated at the first state at least once during the first and third periods and generated at the second state to maintain the gate signals at the second state during the second period.

18. The method of claim 17, wherein the gate signal of the first state has a same voltage level as a gate-on voltage, and the gate signal of the second state has a same voltage level as a gate-off voltage.

19. The method of claim 17, wherein the gate signal of the second state has a same voltage level as the common voltage during the second period.

20. The method of claim 15, wherein the gate signal of the first state is higher than the second state.
